(19) United States
(12) Patent Application Publication
(10) Pub. No.: US 2010/0054745 A1
(43) Pub. Date: Mar. 4, 2010

(54) REMOTE CONTROLLER AND CONTROL METHOD IN CONTROLLED DEVICE USING THE SAME

(75) Inventor: Hyuck-jae LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/399,066

(22) Filed: Mar. 6, 2009

(30) Foreign Application Priority Data
Aug. 28, 2008 (KR) 10-2008-0084366

(51) Int. Cl. H04B 10/00

(52) U.S. Cl. 398/107; 398/106

(57) ABSTRACT

There are provided a remote controller and a control method in a controlled device using the same. The remote controller used for controlling a plurality of controlled devices includes: an input part through which an operation signal for operating the plurality of controlled devices is inputted from a user; a control beam generating part generating a control beam to direct toward the plurality of controlled devices; a controller controlling the control beam generating part to generate a control beam in response to an operation signal inputted through the input part; and a control beam guide part adjusting an emitting angle of the control beam generated by the control beam generating part.

### CROSS-REFERENCE TO RELATED APPLICATION

This application claims priority from Korean Patent Application No. 10-2008-0084366, filed on Aug. 28, 2008 in the Korean Intellectual Property Office, the disclosure of which is incorporated herein by reference.

### BACKGROUND OF INVENTION

1. Field of Invention

Apparatuses and methods consistent with the present invention relate to a remote controller and a control method in a controlled device using the same which can control a plurality of controlled devices with a single remote controller.

2. Description of Related Art

A remote controller is used to control a variety of controlled devices such as a television, DVD player and set top box.

In general, the remote controller transmits a control signal to a controlled device using light emitted from a light source.

The remote controller may be classified into a type for controlling a single controlled device and a type for controlling a plurality of controlled devices.

### SUMMARY OF INVENTION

The present invention provides a remote controller for controlling a plurality of controlled devices, including: an input part through which an operation signal for operating the plurality of controlled devices is inputted from a user; a control beam generating part generating a control beam to direct toward the plurality of controlled devices; a controller controlling the control beam generating part to generate a control beam in response to an operation signal inputted through the input part; and a control beam guide part adjusting an emitting angle of the control beam generated by the control beam generating part.

The remote controller may further include an information receiving part receiving information on the plurality of controlled devices; and a notification part notifying a user of specific information, wherein the controller may control the notification part to notify the user of the information on the controlled devices received by the information receiving part.

The input part may include a notification selecting part operating the notification part.

The remote controller may further include a laser pointer, wherein the controller may control the laser pointer to generate a laser beam in response to an operation signal from the input part.

The input part may include a pointer selecting part operating the laser pointer.

The control beam guide part may include a concave mirror, and the control beam may be reflected from the concave mirror to direct toward the controlled devices.

The control beam guide part may alternatively include a convex lens, and the control beam may pass through the convex lens to direct toward the controlled devices.

The control beam guide part may alternatively include reflection members surrounding the control beam generating part, and the control beam may be reflected from the reflection members to direct toward the controlled devices.

The control beam guide part may alternatively include a light tunnel having a predetermined length, and the control beam may pass through the light tunnel to direct toward the controlled devices.

The control beam guide part may be removably provided.

The present also provides a remote controller for controlling a plurality of controlled devices, including: an input part through which an operation signal for operating the plurality of controlled devices is inputted from a user; a control beam generating part generating a control beam to direct toward the plurality of controlled devices; an information receiving part receiving information on the plurality of devices; a notification part notifying a user of specific information; and a controller controlling the notification part to notify the user of the information on the controlled devices received by the information receiving part.

The remote controller may further include a control beam guide part adjusting an emitting angle of a control beam generated by the control beam generating part.

The notification part may include at least one of a display part displaying the information on the controlled devices and an audio signal output part outputting the information on the controlled devices as an audio signal.

The input part may include a notification selecting part operating the notification part.

The present also provides a control method in a controlled device using a remote controller. The method includes: requesting information on the controlled device by the remote controller; transmitting the information on the controlled device by the controlled device; and notifying a user of the information on the controlled device by the remote controller.

The notifying may include at least one of displaying the user of the information on the controlled device and outputting the information on the controlled device as an audio signal.

### BRIEF DESCRIPTION OF DRAWINGS

The exemplary embodiments of the present invention will become apparent and more readily appreciated from the following description of the exemplary embodiments, taken in conjunction with the accompanying drawings, in which:

FIG. 1 is a block diagram illustrating a remote controller according to an exemplary embodiment of the present invention;

FIG. 2 is a schematic diagram illustrating a remote controller according to an exemplary embodiment of the present invention, for use with a plurality of controlled devices;

FIG. 3 is a schematic diagram illustrating a first embodiment of a control beam guide part of a remote controller according to the present invention;

FIG. 4 is a schematic diagram illustrating a second embodiment of a control beam guide part of a remote controller according to the present invention;

FIG. 5 is a schematic diagram illustrating a third embodiment of a control beam guide part of a remote controller according to the present invention;

FIG. 6 is an exploded perspective view illustrating a fourth embodiment of a control beam guide part of a remote controller according to the present invention;

FIG. 7 is a schematic diagram illustrating the fourth embodiment of a control beam guide part of a remote controller according to the present invention;

FIG. 8 is a schematic diagram illustrating a display part of a notification part in a remote controller according to an exemplary embodiment of the present invention;

FIG. 9 is a schematic diagram illustrating an audio signal output part of a notification part in a remote controller according to an exemplary embodiment of the present invention;

FIG. 10 is a schematic diagram illustrating a remote controller including a laser pointer according to an exemplary embodiment of the present invention;

FIG. 11 is a block diagram illustrating a remote controller according to another exemplary embodiment of the present invention;

FIG. 12 is a schematic diagram illustrating a remote controller according to another exemplary embodiment of the present invention, for use with a plurality of controlled devices; and

FIG. 13 is a flowchart illustrating a control method in a plurality of controlled devices using a remote controller according to an exemplary embodiment of the present invention.

### DETAILED DESCRIPTION OF EXEMPLARY EMBODIMENTS

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures. Repetitive description to like elements of different embodiments may be omitted as necessary.

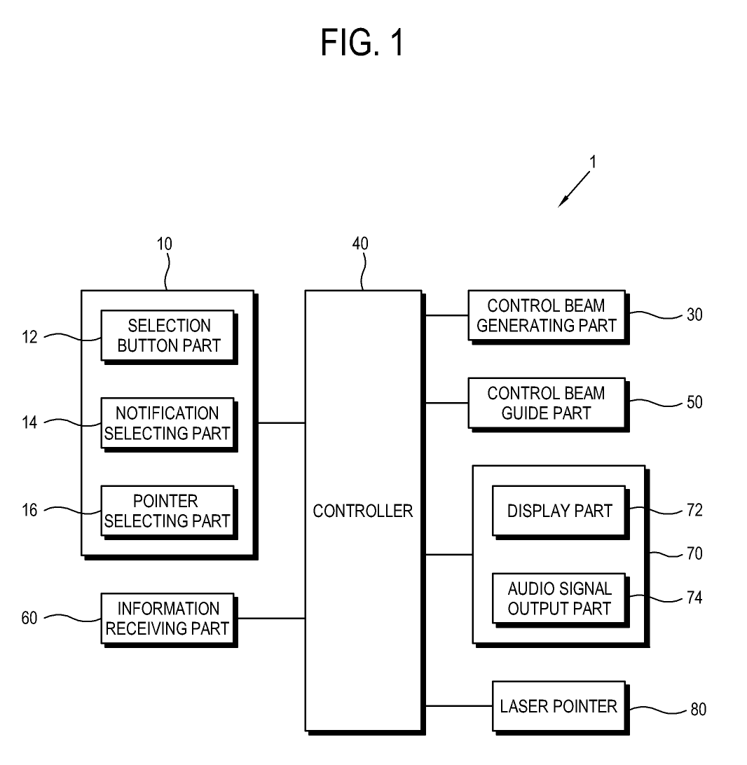

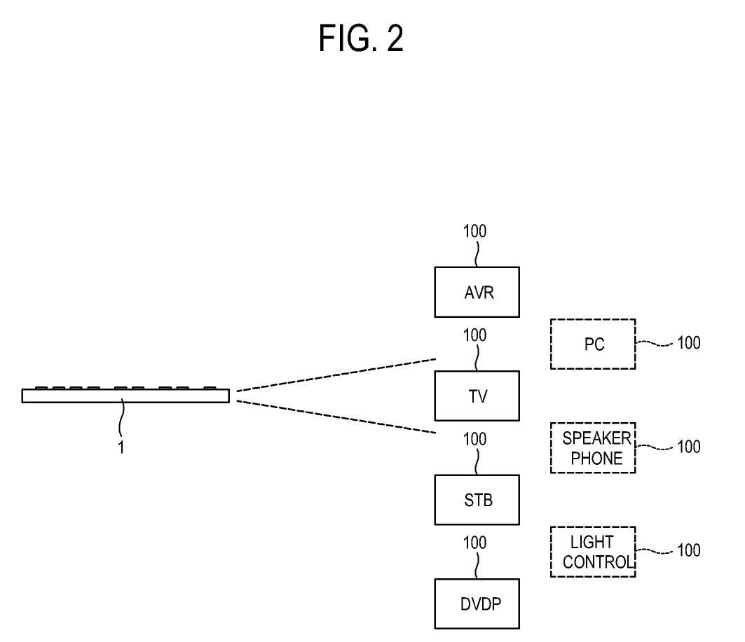

As shown in FIG. 1, a remote controller 1 for use with a plurality of controlled devices 100 (see FIG. 2) according to a first exemplary embodiment of the present invention includes an input part 10 through which user input or an operation signal is received; a control beam generating part 30 for generating a control beam; a controller 40 controlling for controlling the control beam generating part 30 to generate a control beam; and a control beam guide part 50 for adjusting an emitting angle of the control beam.

The input part 10 receives user input or an operation signal for operating the plurality of controlled devices 100 from a user. The input part 10 includes a selection button part 12 for selecting a variety of operations of the controlled device 100. For example, if the controlled device 100 is a television, the selection button part 12 may include buttons for adjusting channels and the volume of the television.

The input part 10 may further include a notification selecting part 14 and a pointer selecting part 16 for transmitting the user input or an operation signal to a notification part 70 and a laser pointer 80, which will be described later.

The control beam generating part 30 generates a control beam to direct toward the plurality of the controlled devices 100. To this end, the control beam generating part 30 includes a light source such as an LED for emitting light. A plurality of LEDs having a plurality of colors and wavelengths may be used the light source depending on the distance between the remote controller 1 and the plurality of controlled devices 100.

The controller 40 controls the control beam generating part 30 to generate a control beam in response to user input or an operation signal received at the input part 10. For example, the controller 40 may control the control beam generating part 30 to generate a control beam for adjusting the volume of the controlled device in response to a corresponding operation signal.

The controller 40 may respectively control the notification part 70 and the laser pointer 80 in response to user input or operation signals received at the notification selecting part 14 and the pointer selecting part 16, which will be further described later.

The control beam guide part 50 adjusts an emitting angle of the control beam generated by the control beam generating part 30 to control any one of the plurality of controlled devices 100 as shown in FIG. 2. For example, in order to adjust the volume of a specific one of the plurality of controlled devices such as a television, DVD player and set top box, the control beam guide part 50 prevents the same control beam from directing toward any other controlled device 100, thereby preventing an undesired operation of the controlled devices 100.

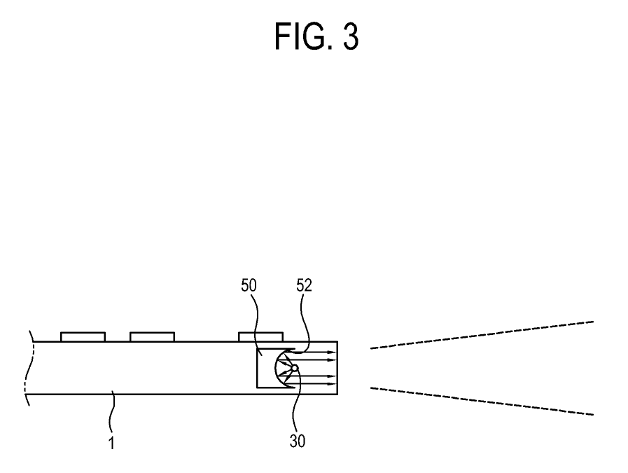

The control beam guide part 50 may include various embodiments as shown in FIGS. 3 through 7.

As shown in FIG. 3, a first embodiment of the control beam guide part 50 includes a concave mirror 52. The concave mirror 52 reflects a control beam from the control beam generating part 30 to adjust an angle of the control beam directing toward the controlled device 100.

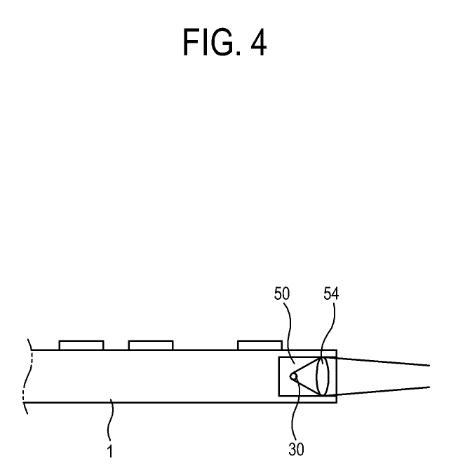

As shown in FIG. 4, a second embodiment of the control beam guide part 50 includes a convex lens 54. The convex lens 54 adjusts a focal distance of a control beam from the control beam generating part 30 to adjust an angle of the control beam directing toward the controlled device 100. The focal distance of the convex lens 54 may be varied suitably as necessary.

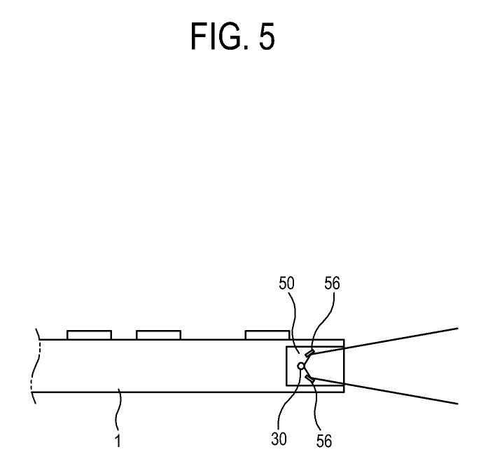

As shown in FIG. 5, a third embodiment of the control beam guide part 50 includes reflection members 56 surrounding the control beam generating part 30. The reflection members 56 may include reflection mirrors.

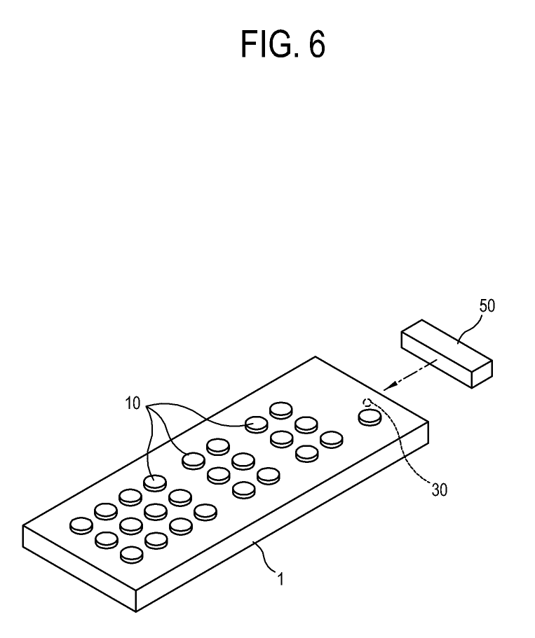

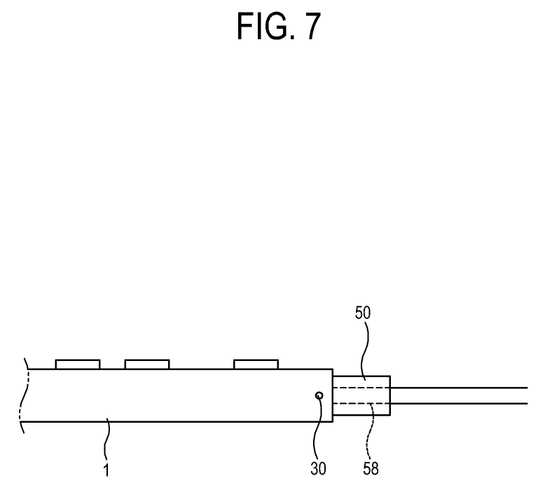

As shown in FIGS. 6 and 7, a fourth embodiment of the control beam guide part 50 includes a light tunnel 58 having a predetermined length. The control beam guide part 50 including the light tunnel 58 is removably coupled in a front face of the remote controller 1 adjacent to the control beam generating part 30. While the control beam guide part 30 is not used, the control beam guide part 30 may be removably coupled to another area of the remote controller 1.

As shown in FIG. 1, the remote controller 1 may further include an information receiving part 60, and the notification part 70.

The information receiving part 60 receives information on a specific controlled device 100 toward which the remote controller 1 is directed to, through communication of the remote controller 1 with the specific controlled device 100. The notification part 70 notifies a user of the received information on the specific controlled device 100. In this respect, the controller 40 controls the notification part 70 to notify the user of the received information.

The notification part 70 is operated by user input or an operation signal received at the notification selecting part 14. The notification selecting part 14 may turn on the notification part 70 when the distance between the specific controlled device 100 and any other controlled device 10 is too short. Thus, it is possible to notify a user of information on the specific controlled devices 100 through the notification part 70, to thereby prevent an undesired operation which may be generated when the distance between the adjacent controlled devices 100 is too short. To the contrary, the notification part 70 may be turned off when the distance between the specific controlled device 100 and the adjacent controlled device 100 is sufficiently long.

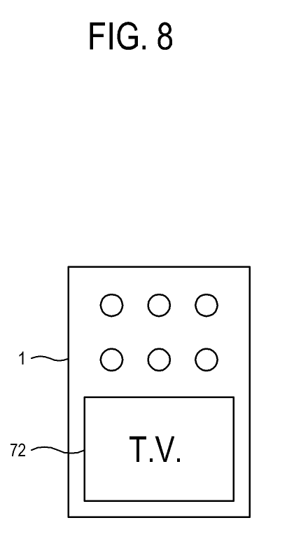

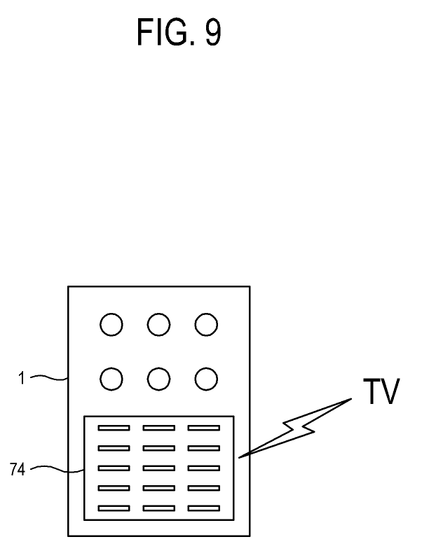

As shown in FIGS. 8 and 9, the notification part 70 may include at least one of a display part 72 for displaying information on the controlled devices 100, and an audio signal output part 74 for outputting information on the controlled devices 100 as an audio signal.

The display part 72 displays information on the controlled devices 100 received through the information receiving part 60 in response to an operation signal from the notification selecting part 14, under the control of the controller 40.

The audio signal output part 72 outputs the information on the received information of the controlled devices 100 as an audio signal in response to the operation signal from the notification selecting part 14, under the control of the controller 40.

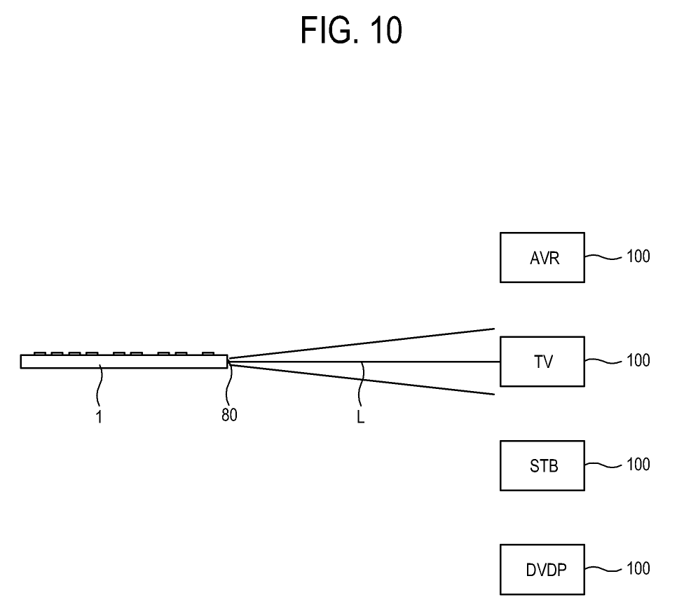

As shown in FIG. 10, the remote controller 1 may further include the laser pointer 80.

The laser pointer 80 is disposed adjacent to the control beam generating part 30. The laser pointer 80 emits a laser beam L in response to an operation signal from the pointer selecting part 16 to visually guide the specific controlled device 100 toward which the remote controller 1 directs, thereby preventing an undesired operation of any other controlled device 100.

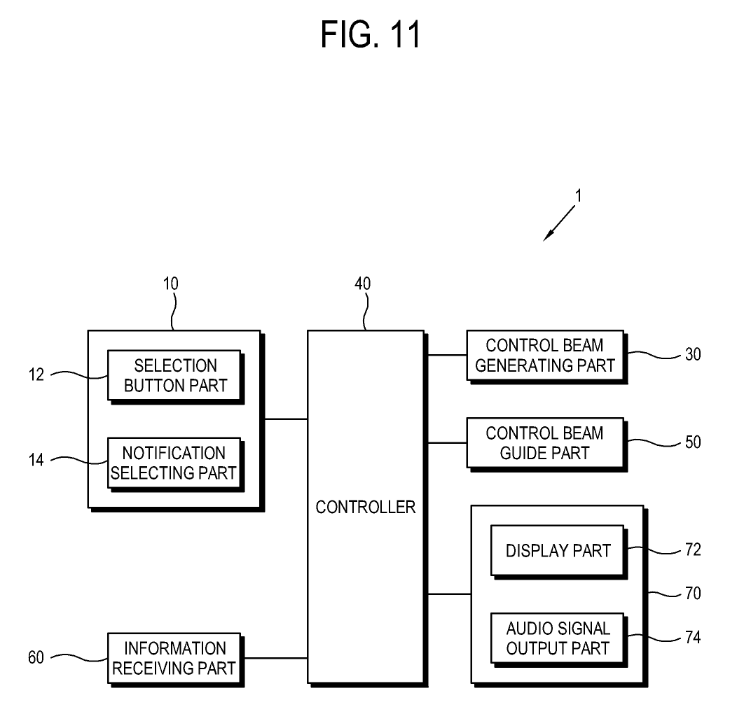

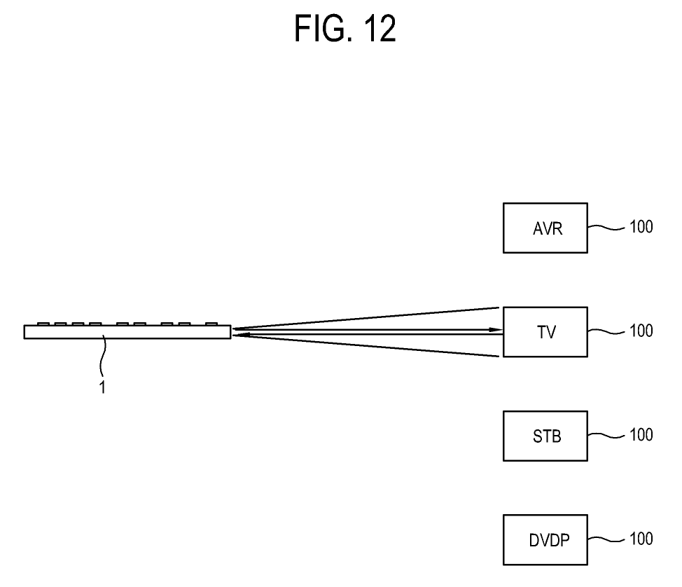

As shown in FIGS. 11 and 12, a remote controller 1 according to a second exemplary embodiment of the present invention includes an input part 10 through which user input or an operation signal for operating a plurality of controlled devices 100 is received from a user; a control beam generating part 30 for generating a control beam to direct toward the plurality of controlled devices 100; an information receiving part 60 for receiving information on the controlled devices 100; a notification part 70 for notifying a user of specific information; and a controller 40 for controlling the notification part 70 to notify a user of the information on the controlled devices 100 received through the information receiving part 60.

The input part 10 includes a selection button part 12 and a notification selecting part 14, unlike the first embodiment.

The notification part 70 includes at least one of a display part 72 for displaying the information on the controlled devices 100 received through the information receiving part 60, and an audio signal output part 74 for outputting the received information on the controlled devices 100 as an audio signal, like the first embodiment.

The remote controller 1 may further include a control beam guide part 50 for adjusting an emitting angle of a control beam generated by the control beam generating part 30 when the distance between the adjacent controlled devices 100 is too short.

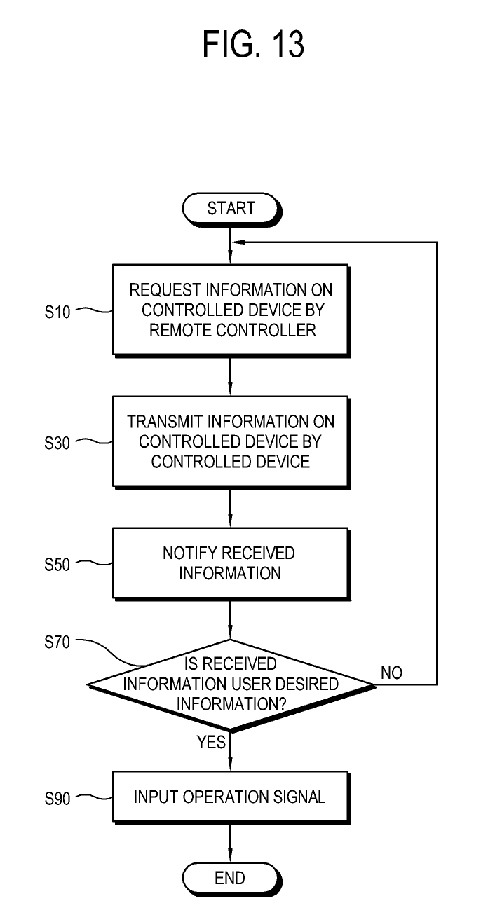

Hereinafter, a control method in a controlled device 100 according to an exemplary embodiment of the present invention will be described with reference to FIG. 13.

Firstly, the remote controller 1 directs toward a specific one of the plurality of controlled devices 100 and requests information on the specific controlled device 100 (S10). In this respect, the notification part 70 is in a turned-on state.

Then, the remote controller 1 receives the information on the specific controlled device through the information receiving part 60 (S30), and then notifies a user of the received information through the notification part 70 (S50).

The controller 40 determines whether the received information is user desired information (S70).

If it is determined that the received information is the user desired one, a user inputs an operation signal for operating the specific controlled device 100 through the selection button part 12 (S90).

As described above, a remote controller according to the present invention can adjust an emitting angle of a control beam to direct toward a specific controlled device, thereby preventing an undesired operation of any other controlled device.

Further, the remote controller can control a specific controlled device by receiving information on the controlled device.

Furthermore, the remote controller can control a specific controlled device using a laser pointer.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A remote controller for controlling a plurality of controlled devices, comprising:
an input part through which user input for operating at least one of the plurality of controlled devices, is received from a user;
a control beam generating part which generates a control beam directed toward at least one of the plurality of controlled devices;
a controller which controls the control beam generating part to generate the control beam in response to the user input received at the input part; and
a control beam guide part which adjusts an emitting angle of the control beam generated by the control beam generating part.

2. The remote controller according to claim 1, further comprising an information receiving part which receives information on one of the plurality of controlled devices; and a notification part which notifies the user of the information, wherein the controller controls the notification part to notify the user of the information by the information receiving part.

3. The remote controller according to claim 2, wherein the input part comprises a notification selecting part which operates the notification part.

4. The remote controller according to claim 1, further comprising a laser pointer, wherein the controller controls the laser pointer to generate a laser beam in response to a signal from the input part.

5. The remote controller according to claim 4, wherein the input part comprises a pointer selecting part which operates the laser pointer.

6. The remote controller according to claim 1, wherein the control beam guide part comprises a concave mirror, and the control beam is reflected from the concave mirror toward the at least one of the plurality of controlled devices.

7. The remote controller according to claim 1, wherein the control beam guide part comprises a convex lens, and the control beam passes through the convex lens toward the at least one of the plurality of controlled devices.

8. The remote controller according to claim 1, wherein the control beam guide part comprises reflection members which surround the control beam generating part, and the control beam is reflected from the reflection members toward the at least one of the plurality of controlled devices.

9. The remote controller according to claim 1, wherein the control beam guide part comprises a light tunnel having a predetermined length, and the control beam passes through the light tunnel toward the at least one of the plurality of controlled devices.

10. The remote controller according to claim 9, wherein the control beam guide part is removably provided.

11. A remote controller for controlling a plurality of controlled devices, comprising:
an input part through which user input for operating at least one of the plurality of controlled devices is received from a user;
a control beam generating part which generates a control beam directed toward the plurality of controlled devices;
an information receiving part which receives information on one of the plurality of devices;
a notification part which notifies the user of the information; and
a controller which controls the notification part to notify the user of the information received by the information receiving part.

12. The remote controller according to claim 11, further comprising a control beam guide part which adjusts an emitting angle of a control beam generated by the control beam generating part.

13. The remote controller according to claim 11, wherein the notification part comprises at least one of a display part which displays the information on the controlled devices and an audio signal output part which outputs the information as an audio signal.

14. The remote controller according to claim 13, wherein the input part comprises a notification selecting part which operates the notification part.

15. A control method in a controlled device using a remote controller, comprising:
requesting information on the controlled device by the remote controller;
transmitting the information on the controlled device by the controlled device; and
notifying a user of the information on the controlled device by the remote controller.

16. The control method according to claim 15, wherein the notifying comprises at least one of displaying to the user the information on the controlled device and outputting the information on the controlled device as an audio signal.
